(19) United States
(12) Patent Application Publication
(10) Pub. No.: US 2025/0392192 A1
(43) Pub. Date: Dec. 25, 2025

(54) ELECTRIC DRIVE UNIT FOR A VEHICLE

(71) Applicant: Schaeffler Technologies AG & Co. KG, Herzogenaurach (DE)

(72) Inventor: Tyler Elfers, Medina, OH (US)

(73) Assignee: Schaeffler Technologies AG & Co. KG, Herzogenaurach (DE)

(21) Appl. No.: 19/233,551

(22) Filed: Jun. 10, 2025

Related U.S. Application Data
(60) Provisional application No. 63/662,645, filed on Jun. 21, 2024.

(51) Int. Cl. H02K 7/116; F16H 9/26; H02K 7/00; H02K 7/08

(52) U.S. Cl. CPC H02K 7/116; F16H 9/26; H02K 7/006; H02K 7/08; F16H 2306/50

(57) ABSTRACT

An electric drive unit includes a motor that rotates a rotor shaft about an axis and first and second planetary gearsets. The first gearset includes a sun gear, planet gears, a ring gear, and a carrier structure. The second gearset is coupled with the first gearset. During rotation of the shaft in a first direction in a high gear state, the sun gear rotates about the axis, planet gears rotate about planet gear axes and revolve about the axis, carrier structure rotates about the axis, and ring gear is substantially stationary relative to the axis. During rotation of the shaft in the first direction in a low gear state, the sun gear rotates about the axis, planet gears rotate about planet gear axes and revolve about the axis, carrier structure rotates about the axis, and ring gear rotates about the axis in a second direction opposite the first direction.

### CROSS-REFERENCE TO RELATED APPLICATIONS

This application claims priority under 35 U.S.C. § 119(e) and the benefit of U.S. Provisional Patent Application No. 63/662,645, entitled ELECTRIC DRIVE UNIT FOR A VEHICLE, filed on Jun. 21, 2024, which is incorporated herein by reference in its entirety.

### FIELD OF THE DISCLOSURE

The present disclosure generally relates to electric drive units for vehicles. More specifically, the present disclosure relates to an electric drive unit that includes a gear system and is operable between a high gear state and a low gear state.

### BACKGROUND OF THE DISCLOSURE

Electric drive units often include gearboxes having a transmission and/or differential that transmit torque from a motor to wheels of a vehicle.

### SUMMARY OF THE DISCLOSURE

According to a first aspect of the present disclosure, an electric drive unit includes a motor that drives rotation of a rotor shaft about an axis, a first planetary gearset, and a second planetary gearset. The first planetary gearset includes a first sun gear coupled to the rotor shaft, a plurality of first planet gears that interface with the first sun gear, a first ring gear that interfaces with the plurality of first planet gears, and a first carrier structure operably coupled with the plurality of first planet gears, such that revolution of the first planet gears rotates the first carrier structure. The second planetary gearset is operably coupled with the first planetary gearset, such that during rotation of the rotor shaft by the motor in a first rotational direction in a high gear state of the electric drive unit, the first sun gear rotates about the axis, the first planet gears rotate about respective first planet gear axes and revolve about the axis, the first carrier structure rotates about the axis, and the first ring gear is substantially rotationally stationary relative to the axis, and, during rotation of the rotor shaft by the motor in the first rotational direction in a low gear state of the electric drive unit, the first sun gear rotates about the axis, the first planet gears rotate about the respective first planet gear axes and revolve about the axis, the first carrier structure rotates about the axis, and the first ring gear rotates about the axis in a second rotational direction that is opposite the first rotational direction.

Embodiments of the first aspect of the disclosure can include any one or a combination of the following features:
the first carrier structure is operable to output a first amount of torque in the high gear state and a second amount of torque in the low gear state, and wherein the first amount is less than the second amount;
a differential is operably coupled with the first carrier structure;
the first carrier structure includes a pinion that is configured to interface with a wheel gear operably coupled with the differential;
the second planetary gearset includes a second sun gear, a plurality of second planet gears that interface with the second sun gear, a second ring gear that interfaces with the plurality of second planet gears, and a second carrier structure to which the plurality of second planet gears are operably coupled, the second carrier structure being rotationally fixed relative to the axis;
a first connector structure extends between the first ring gear and the second sun gear to rotationally fix the first ring gear relative to the second sun gear with respect to the axis;
a second connector structure is fixed to and extends from the second ring gear, and a shifter operably coupled with the second connector structure and operable between a first condition, wherein the shifter couples the second connector structure to a housing to define the high gear state of the electric drive unit, and a second condition, wherein the shifter couples the first carrier structure with the second connector structure to define the low gear state of the electric drive unit;
a first bearing extends between the rotor shaft and the first connector structure, and a second bearing extends between the first carrier structure and the second connector structure;
during rotation of the rotor shaft by the motor in the first rotational direction in the high gear state, the first connector structure, the second sun gear, the plurality of second planet gears, the second carrier structure, the second ring gear, and the second connector structure are substantially rotationally stationary relative to the axis; and
during rotation of the rotor shaft by the motor in the first rotational direction in the low gear state, the second carrier structure is substantially rotationally stationary relative to the axis, the second connector structure rotates with the first carrier structure about the axis, the second ring gear rotates with the second connector structure about the axis, the second planet gears rotate about respective second planet gear axes, the second sun gear rotates about the axis, and the first connector structure rotates with the second sun gear about the axis.

According to a second aspect of the present disclosure, an electric drive unit includes a housing, a motor that drives rotation of a rotor shaft about an axis, a first planetary gearset, a second planetary gearset, a first connector structure, a second connector structure, and a shift. The first planetary gearset includes a first sun gear coupled to the rotor shaft, a plurality of first planet gears that interface with the first sun gear, a first ring gear that interfaces with the plurality of first planet gears, and a first carrier structure operably coupled with the plurality of first planet gears, such that revolution of the first planet gears rotates the first carrier structure. The second planetary gearset includes a second sun gear, a plurality of second planet gears that interface with the second sun gear, a second ring gear that interfaces with the plurality of second planet gears, and a second carrier structure to which the plurality of second planet gears are operably coupled, the second carrier structure being rotationally fixed relative to the axis. The first connector structure extends between the first ring gear and the second sun gear to rotationally fix the first ring gear relative to the second sun gear with respect to the axis. The second connector structure is fixed to and extends from the second ring gear. The shifter is operably coupled with the second connector structure and operates between a first condition, wherein the shifter couples the second connector structure to the housing to define a high gear state of the electric drive unit, and a second condition, wherein the shifter couples the first carrier structure with the second connector structure to define a low gear state of the electric drive unit. During rotation of the rotor shaft by the motor in a first rotational direction in the high gear state, the first sun gear rotates about the axis, the first planet gears rotate about respective first planet gear axes and revolve about the axis, the first carrier structure rotates about the axis, and the first ring gear, the first connector structure, the second sun gear, the plurality of second planet gears, the second carrier structure, the second ring gear, and the second connector structure are substantially rotationally stationary relative to the axis. During rotation of the rotor shaft by the motor in the first rotational direction in the low gear state, the second carrier structure is substantially rotationally stationary relative to the axis, the first sun gear rotates about the axis, the first planet gears rotate about the respective first planet gear axes and revolve about the axis, the first carrier structure rotates about the axis, the second connector structure rotates with the first carrier structure about the axis, the second ring gear rotates with the second connector structure about the axis, the second planet gears rotate about respective second planet gear axes, the second sun gear rotates about the axis, the first connector structure rotates with the second sun gear about the axis, and the first ring gear rotates with the first connector structure about the axis in a second rotational direction that is opposite the first rotational direction.

Embodiments of the second aspect of the disclosure can include any one or a combination of the following features:
the first carrier structure is operable to output a first amount of torque in the high gear state and a second amount of torque in the low gear state, wherein the first amount is less than the second amount;
a differential is operably coupled with the first carrier structure;
the first carrier structure includes a pinion that is configured to interface with a wheel gear operably coupled with the differential; and
a first bearing extends between the rotor shaft and the first connector structure, and a second bearing that extends between the first carrier structure and the second connector structure.

According to a third aspect of the present disclosure, a gear system includes a first planetary gearset including a first sun gear configured to rotate about an axis, a plurality of first planet gears that interface with the first sun gear, a first ring gear that interfaces with the plurality of first planet gears, and a first carrier structure operably coupled with the plurality of first planet gears, such that the revolution of the first planet gears rotates the first carrier structure. The first carrier structure is operably coupled with the first ring gear, such that rotation of the first sun gear about the axis in a first rotational direction prompts rotation of the first carrier structure about the axis in the first rotational direction and rotation of the first ring gear about the axis in a second rotational direction opposite the first rotational direction.

Embodiments of the third aspect of the disclosure can include any one or a combination of the following features:
a second gearset operably couples the first carrier structure with the first ring gear;
the second gearset is a second planetary gearset that includes a second sun gear, a plurality of second planet gears that interface with the second sun gear, a second ring gear that interfaces with the plurality of second planet gears, and a second carrier structure to which the plurality of second planet gears are operably coupled, the second carrier structure being rotationally fixed relative to the axis;
the first carrier structure and the second ring gear are configured to rotate together at a common rate of rotation about the axis; and
the first ring gear and the second sun gear are configured to rotate together at a common rate of rotation about the axis.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic view of a vehicle that includes an electric drive unit, according to one embodiment;

FIG. 2 is a cross-sectional schematic view of an electric drive unit that includes a motor, a gear system having first and second planetary gearsets and a differential, and a housing that houses the motor and the gear system, according to one embodiment;

FIG. 3 is an enlarged view of area Ill of FIG. 2, illustrating a portion of the gear system of FIG. 2 with the electric drive unit in a high gear state and a force transfer path (bold dashed line) from a rotor shaft to a pinion via the gear system in the high gear state, according to one embodiment; and

FIG. 4 is an enlarged view of a portion of the electric drive unit of FIG. 2 corresponding with area III of FIG. 2, illustrating a portion of the gear system with the electric drive unit in a low gear state and a force transfer path (bold dashed line) from the rotor shaft to the pinion via the gear system in the low gear state, according to one embodiment.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along the axis of a shaft configured to rotate in operation of the apparatus described herein. Further, the term “radial” and derivatives thereof, such as “radially,” shall be understood in relation to the axis of the aforementioned shaft. For example, “radially outboard” refers to further away from the axis, while “radially inboard” refers to nearer to the axis. The term “circumferential” and derivatives thereof, such as “circumferentially,” shall be understood in relation to the axis of the aforementioned shaft.

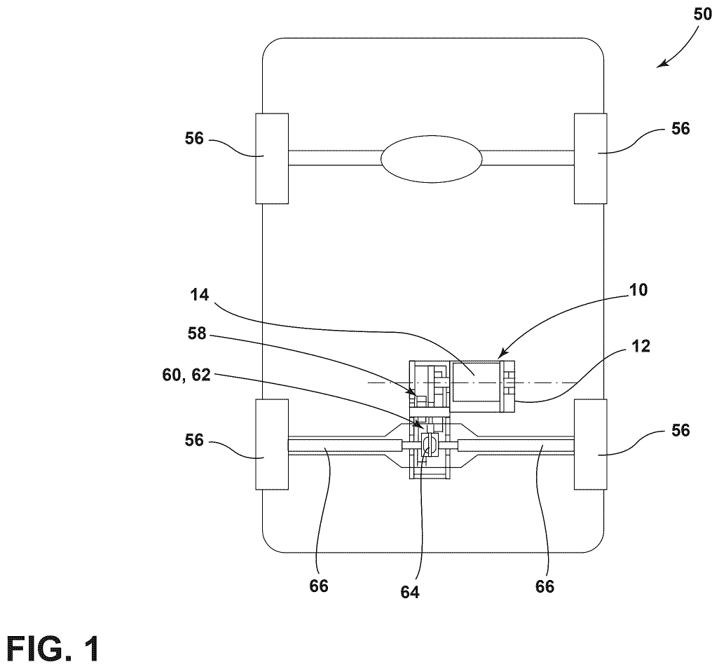

Referring now to FIGS. 1-4, an electric drive unit 10 includes a housing 12. A motor 14 housed by the housing 12 is configured to drive rotation of a rotor shaft 16 about an axis 18. A first planetary gearset 20 includes a first sun gear 22 that is coupled to the rotor shaft 16, a plurality of first planet gears 24 that interface with the first sun gear 22, a first ring gear 26 that interfaces with the plurality of first planet gears 24, and a first carrier structure 28. The first carrier structure 28 is operably coupled with the plurality of first planet gears 24, such that revolution of the first planet gears 24 rotates the first carrier structure 28. The electric drive unit 10 further includes a second planetary gearset 30. The second planetary gearset 30 includes a second sun gear 32, a plurality of second planet gears 34 that interface with the second sun gear 32, a second ring gear 36 that interfaces with the plurality of second planet gears 34, and a second carrier structure 38. The plurality of second planet gears 34 are operably coupled to the second carrier structure 38. The second carrier structure 38 is rotationally fixed relative to the axis 18 about which the rotor shaft 16 is configured to rotate. A first connector structure 40 extends between the first ring gear 26 and the second sun gear 32 to rotationally fix the first ring gear 26 relative to the second sun gear 32 with respect to the axis 18. A second connector structure 42 is fixed to and extends from the second ring gear 36. A shifter 44 is operably coupled with the second connector structure 42 and is operable between a first condition, wherein the shifter 44 couples the second connector structure 42 to the housing 12 to define a high gear state of the electric drive unit 10, and a second condition, wherein the shifter 44 couples the first carrier structure 28 with the second connector structure 42 to define a low gear state of the electric drive unit 10.

During rotation of the rotor shaft 16 by the motor 14 in a first rotational direction in the high gear state, the first sun gear 22 rotates about the axis 18, the first planet gears 24 rotate about respective first planet gear axes 46 and revolve about the axis 18, and the first carrier structure 28 rotates about the axis 18. Further, the first ring gear 26, the first connector structure 40, the second sun gear 32, the plurality of second planet gears 34, the second carrier structure 38, the second ring gear 36, and the second connector structure 42 are substantially rotationally stationary relative to the axis 18.

During rotation of the rotor shaft 16 by the motor 14 in the first rotational direction in the low gear state, the second carrier structure 38 is substantially rotationally stationary relative to the axis 18. Further, the first sun gear 22 rotates about the axis 18, the first planet gears 24 rotate about the respective first planet gear axes 46 and revolve about the axis 18, the first carrier structure 28 rotates about the axis 18, the second connector structure 42 rotates with the first carrier structure 28 about the axis 18, the second ring gear 36 rotates with the second connector structure 42 about the axis 18, the second planet gears 34 rotate about respective second planet gear axes 48, the second sun gear 32 rotates about the axis 18, the first connector structure 40 rotates with the second sun gear 32 about the axis 18, and the first ring gear 26 rotates with the first connector structure 40 about the axis 18 in a second rotational direction that is opposite the first rotational direction.

Referring now to FIG. 1, a vehicle 50 is illustrated. The vehicle 50 may be an electric vehicle and/or a hybrid electric vehicle. In the embodiment illustrated in FIG. 1, the vehicle 50 includes the electric drive unit 10. The electric drive unit 10 includes the motor 14. The motor 14 can include a stator 52 and a rotor 54 and may be configured to drive rotation of the rotor shaft 16 about the axis 18. In various implementations, the rotor shaft 16 is operably coupled with at least one wheel 56 of the vehicle 50, such that rotation of the rotor shaft 16 drives rotation of the at least one wheel 56. In various implementations, the electric drive unit 10 of the vehicle 50 includes a gear system 58. In an exemplary implementation, the gear system 58 can include a plurality of gearsets. For example, the gear system 58 may include a first gearset 60, a second gearset 62, and/or a differential 64 that is operably coupled with the first and/or second gearsets 60, 62. In various embodiments, the first gearset 60 may be the first planetary gearset 20, the second gearset 62 may be the second planetary gearset 30, and the differential 64 may be operably coupled with the first and/or second planetary gearsets 20, 30, as described further herein. The one or more gearsets may be configured to interface with the rotor shaft 16 and the differential 64, and the differential 64 may be configured to interface with half shafts 66 that are coupled with wheels 56 of the vehicle 50. As such, rotation of the rotor shaft 16 by the electric drive unit 10 may drive rotation of the half shafts 66 and the attached wheels 56 of the vehicle 50 via the operable coupling of the half shafts 66 to the rotor shaft 16 by the one or more gearsets and the differential 64.

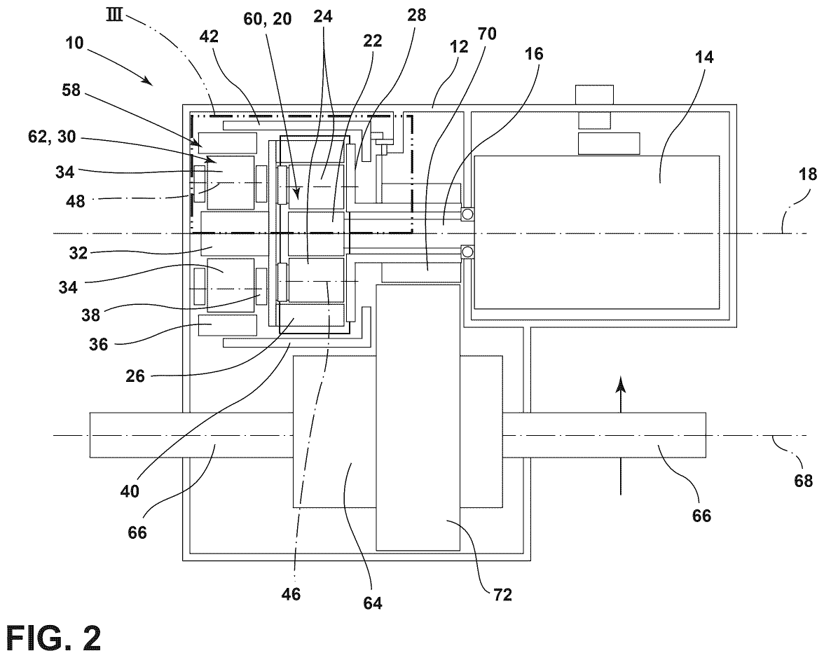

Referring now to FIGS. 1 and 2, the electric drive unit 10 includes the housing 12. The housing 12 houses the motor 14, as illustrated in FIGS. 1 and 2. In some embodiments, the housing 12 can be an assembly of a plurality of components. For example, the housing 12 may be a die-cast aluminum housing that is formed of a plurality of components. In the embodiment illustrated in FIG. 2, the housing 12 houses the motor 14 and the gear system 58 of the electric drive unit 10. As illustrated, the rotor shaft 16 and portions of the two half shafts 66 of the vehicle 50 are disposed within the housing 12. The half shafts 66 of the vehicle 50 are configured to rotate about an offset axis 68 that is radially offset from and parallel to the axis 18 about which the rotor shaft 16 is configured to rotate, in the illustrated embodiment.

Referring now to FIGS. 2-4, the gear system 58 of the electric drive unit 10 can include the one or more gearsets. In various implementations, the electric drive unit 10 includes the first planetary gearset 20. The first planetary gearset 30 includes the first sun gear 22 that is coupled to the rotor shaft 16. In various implementations, the first sun gear 22 is operably coupled to the rotor shaft 16, such that the first sun gear 22 and the rotor shaft 16 are configured to rotate together at a common rate of rotation about the axis 18. The first planetary gearset 20 includes the plurality of first planet gears 24. The plurality of first planet gears 24 interface with the first sun gear 22, as illustrated in FIGS. 2-4. The first planetary gearset 20 further includes the first ring gear 26 that interfaces with the plurality of first planet gears 24. As illustrated in FIGS. 2-4, the plurality of first planet gears 24 are positioned radially between the first sun gear 22 and the first ring gear 26. The first planetary gearset 20 includes the first carrier structure 28. The first carrier structure 28 is operably coupled with the plurality of first planet gears 24, such that revolution of the first planet gears 24 about the axis 18 rotates the first carrier structure 28 about the axis 18.

In various implementations, the first planet gears 24 are operable to rotate relative to the first carrier structure 28 about respective first planet gear axes 46 in operation of the first planetary gearset 20. The first planetary gear axes 46 are configured to revolve with the first planet gears 24 about the axis 18, in various embodiments. It is contemplated that the first carrier structure 28 may extend axially beyond various portions of the first planetary gearset 20, such as the first ring gear 26 and/or the first sun gear 22. Further, it is contemplated that the first carrier structure 28 may be an assembly of a plurality of components that are fixed to each other. For example, in the embodiment illustrated in FIG. 2, the first carrier structure 28 of the first planetary gearset 20 extends axially beyond the first ring gear 26 and the first sun gear 22 toward the motor 14 of the electric drive unit 10, and the first carrier structure 28 includes a pinion 70 thereon. The pinion 70 is configured to interface with a wheel gear 72 that is operably coupled with the differential 64, such that rotation of the pinion 8-with the first carrier structure 28 prompts rotation of the wheel gear 72 to operate the differential 64 and drive rotation of the half shafts 66 of the vehicle 50 engaged therewith.

In some implementations, the first carrier structure 28 is operably coupled with the first ring gear 26, such that rotation of the first sun gear 22 about the axis 18 in a first rotational direction prompts rotation of the first carrier structure 28 about the axis 18 in the first rotational direction and rotation of the first ring gear 26 about the axis 18 in a second rotational direction opposite the first rotational direction. For example, in some implementations, the first carrier structure 28 is operably coupled with the first ring gear 26 via the second gearset 62, such as the second planetary gearset 30, such that rotation of the first sun gear 22 about the axis 18 in the first rotational direction prompts rotation of the first carrier structure 28 about the axis 18 in the first rotational direction and rotation of the first ring gear 26 about the axis 18 in a second rotational direction opposite the first rotational direction, as described further herein.

Referring still to FIGS. 2-4, the gear system 58 includes the second gearset 62. As illustrated in FIGS. 2-4, the second gearset 62 is the second planetary gearset 30. The second planetary gearset 30 includes the second sun gear 32, the plurality of second planet gears 34 that interface with the second sun gear 32, the second ring gear 36 that interfaces with the plurality of second planet gears 34, and the second carrier structure 38 to which the plurality of second planet gears 34 are operably coupled. In various implementations, the second carrier structure 38 is rotationally fixed relative to the axis 18. As such, rotation of the second sun gear 32 about the axis 18 prompts rotation of the second planet gears 34 about respective second planet gear axes 48 that are circumferentially fixed relative to the axis 18, and rotation of the second ring gear 36 about the axis 18. It is contemplated that the second carrier structure 38 may be rotationally fixed relative to the axis 18 via coupling of the second carrier structure 38 to another component of the electric drive unit 10, such as the housing 12.

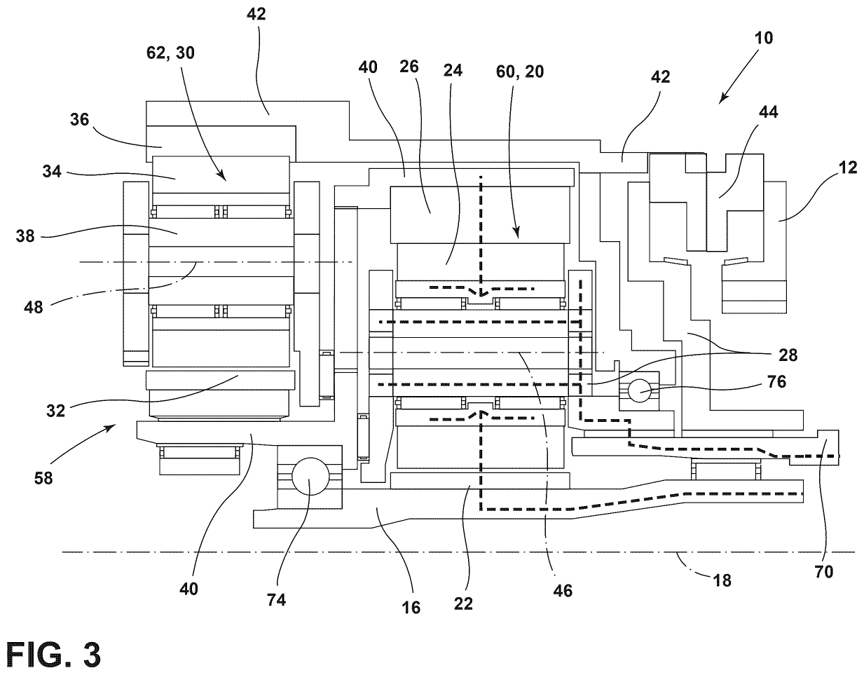

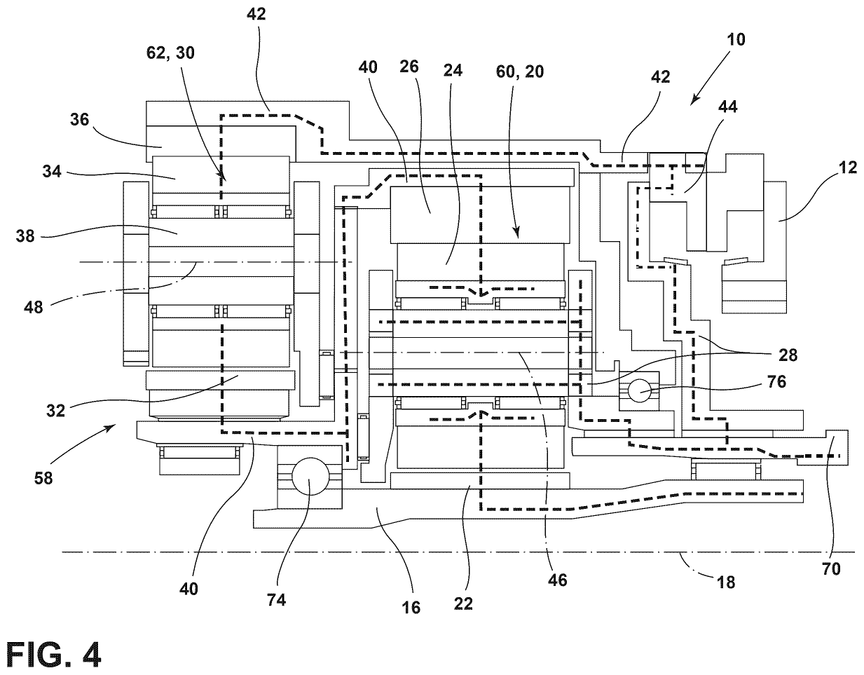

Referring now to FIGS. 3 and 4, in some implementations, the first and second planetary gearsets 20, 30 are operably coupled with each other, such that the first carrier structure 28 of the first planetary gearset 20 and the second ring gear 36 of the second planetary gearset 30 are configured to rotate together at a common rate of rotation about the axis 18. In some implementations, the first and second planetary gearsets 20, 30 are operably coupled with each other, such that the first ring gear 26 and the second sun gear 32 are configured to rotate together at a common rate of rotation about the axis 18. In the embodiment illustrated in FIGS. 3 and 4, the gear system 58 includes the first connector structure 40 and the second connector structure 42. As illustrated in FIGS. 3 and 4, the first connector structure 40 extends between the first ring gear 26 and the second sun gear 32 to rotationally fix the first ring gear 26 relative to the second sun gear 32 with respect to the axis 18. In the illustrated embodiment, the first connector structure 40 is fixed to the first ring gear 26 radially outboard of the portion of the first ring gear 26 that interfaces with the plurality of first planet gears 24, extends axially away from the motor 14 beyond the interfacing portion of the first ring gear 26, extends radially-inboard therefrom axially-between the first carrier structure 28 and the second carrier structure 38, and extends axially away from the motor 14 to the second ring gear 36.

As further illustrated in FIGS. 3 and 4, the second connector structure 42 is fixed to and extends from the second ring gear 36 of the second planetary gearset 30. As illustrated in FIGS. 3 and 4, the second connector structure 42 extends axially toward the motor 14 from the second ring gear 36 of the second planetary gearset 30. In the illustrated embodiment, a portion of the second connector structure 42 extends axially toward the motor 14 axially-beyond the first ring gear 26 of the first planetary gearset 20. The second connector structure 42 may be selectively coupled with the housing 12 of the electric drive unit 10, as illustrated in FIG. 3, and/or with the first carrier structure 28 of the first planetary gearset 20, as illustrated in FIG. 4. In various implementations, the second connector structure 42 may be selectively coupled with the housing 12 and/or the first carrier structure 28 via the shifter 44, as described further herein.

Referring still to FIGS. 3 and 4, the electric drive unit 10 includes the shifter 44. The shifter 44 is coupled to the second connector structure 42 and is configured to be selectively coupled with the housing 12 and/or the first carrier structure 28. As illustrated in FIG. 3, the shifter 44 is operable to enter a first condition, wherein the shifter 44 couples the second connector structure 42 to the housing 12 to define a high gear state of the electric drive unit 10. Further, as illustrated in FIG. 4, the shifter 44 is operable to shift from the first condition to a second condition, wherein the shifter 44 couples the first carrier structure 28 with the second connector structure 42 to define the low gear state of the electric drive unit 10. A variety of types of shifters 44 that are operable to selectively couple the second connector structure 42 to the first carrier structure 28 and selectively couple the second carrier structure 38 to the housing 12 are contemplated.

Referring now to FIG. 3, during rotation of the rotor shaft 16 by the motor 14 in the first rotational direction in the high gear state of the electric drive unit 10, the first sun gear 22 rotates about the axis 18, the first planet gears 24 rotate about respective first planet gear axes 46 and revolve about the axis 18, and the first carrier structure 28 rotates about the axis 18. Further, the first ring gear 26, the first connector structure 40, the second sun gear 32, the plurality of second planet gears 34, the second carrier structure 38, the second ring gear 36, and the second connector structure 42 are substantially rotationally stationary relative to the axis 18 in the high gear state of the electric drive unit 10 during rotation of the rotor shaft 16 by the motor 14 in the first rotational direction.

Referring now to FIG. 4, during rotation of the rotor shaft 16 by the motor 14 in the first rotational direction in the low gear state of the electric drive unit 10, the second carrier structure 38 is substantially rotationally stationary relative to the axis 18. Further, the first sun gear 22 rotates about the axis 18, the first planet gears 24 rotate about respective first planet gear axes 46 and revolve about the axis 18, the first carrier structure 28 rotates about the axis 18, the second connector structure 42 rotates with the first carrier structure 28 about the axis 18, the second ring gear 36 rotates with the second connector structure 42 about the axis 18, the second planet gears 34 rotate about respective second planet gear axes 48, the second sun gear 32 rotates about the axis 18, the first connector structure 28 rotates with the second sun gear 32 about the axis 18, and the first ring gear 26 rotates with the first connector structure 40 about the axis 18 in a second rotational direction that is opposite the first rotational direction.

In various implementations, the first carrier structure 28 is operable to output a first amount of torque in the high gear state and a second amount of torque in the low gear state. The first amount of torque is less than the second amount of torque. In the embodiment illustrated in FIGS. 3 and 4, the first and second connector structures 40, 42 operably couple the first planetary gearset 20 and the second planetary gearset 30. It is contemplated that the first carrier structure 28 of the first planetary gearset 20 may be operably coupled with the first ring gear 26 of the first planetary gearset 20 via a variety of intermediate coupling systems, such that rotation of the first sun gear 32 about the axis 18 in the first rotational direction prompts rotation of the first carrier structure 28 about the axis 18 in the first rotational direction and rotation of the first ring gear 26 about the axis 18 in a second rotational direction opposite the first rotational direction.

Referring still to FIGS. 3 and 4, the electric drive unit 10 can include a plurality of bearings. As illustrated in FIGS. 3 and 4, the electric drive unit 10 includes a first bearing 74 that extends between the rotor shaft 16 and the first connector structure 40, and a second bearing 76 that extends between the first carrier structure 28 and the second connector structure 42.

It is to be understood that variations and modifications can be made on the aforementioned structure without departing from the concepts of the present disclosure, and further it is to be understood that such concepts are intended to be covered by the following claims unless these claims by their language expressly state otherwise

### LIST OF REFERENCE NUMERALS

10 electric drive unit
12 housing
14 motor
16 rotor shaft
18 axis
20 first planetary gearset
22 first sun gear
24 first planet gears
26 first ring gear
28 first carrier structure
30 second planetary gearset
32 second sun gear
34 second planet gears
36 second ring gear
38 second carrier structure
40 first connector structure
42 second connector structure
44 shifter
46 first planet gear axes/axis
48 second planet gear axes/axis
50 vehicle
52 stator
54 rotor
56 wheel
58 gear system
60 first gearset
62 second gearset
64 differential
66 half shafts
68 offset axis
70 pinion
72 wheel gear
74 first bearing
76 second bearing

What is claimed is:

1. An electric drive unit, comprising:
a motor that drives rotation of a rotor shaft about an axis;
a first planetary gearset, comprising:
a first sun gear coupled to the rotor shaft;
a plurality of first planet gears that interface with the first sun gear;
a first ring gear that interfaces with the plurality of first planet gears; and
a first carrier structure operably coupled with the plurality of first planet gears, such that revolution of the first planet gears rotates the first carrier structure; and
a second planetary gearset that is operably coupled with the first planetary gearset, such that during rotation of the rotor shaft by the motor in a first rotational direction in a high gear state of the electric drive unit, the first sun gear rotates about the axis, the first planet gears rotate about respective first planet gear axes and revolve about the axis, the first carrier structure rotates about the axis, and the first ring gear is substantially rotationally stationary relative to the axis, and, during rotation of the rotor shaft by the motor in the first rotational direction in a low gear state of the electric drive unit, the first sun gear rotates about the axis, the first planet gears rotate about the respective first planet gear axes and revolve about the axis, the first carrier structure rotates about the axis, and the first ring gear rotates about the axis in a second rotational direction that is opposite the first rotational direction.

2. The electric drive unit of claim 1, wherein the first carrier structure is operable to output a first amount of torque in the high gear state and a second amount of torque in the low gear state, and wherein the first amount is less than the second amount.

3. The electric drive unit of claim 1, further comprising:
a differential that is operably coupled with the first carrier structure.

4. The electric drive unit of claim 3, wherein the first carrier structure includes a pinion that is configured to interface with a wheel gear operably coupled with the differential.

5. The electric drive unit of claim 1, wherein the second planetary gearset comprises:
a second sun gear;
a plurality of second planet gears that interface with the second sun gear;
a second ring gear that interfaces with the plurality of second planet gears; and
a second carrier structure to which the plurality of second planet gears are operably coupled, the second carrier structure being rotationally fixed relative to the axis.

6. The electric drive unit of claim 5, further comprising:
a first connector structure that extends between the first ring gear and the second sun gear to rotationally fix the first ring gear relative to the second sun gear with respect to the axis.

7. The electric drive unit of claim 6, further comprising:
a second connector structure that is fixed to and extends from the second ring gear; and
a shifter operably coupled with the second connector structure and operable between a first condition, wherein the shifter couples the second connector structure to a housing to define the high gear state of the electric drive unit, and a second condition, wherein the shifter couples the first carrier structure with the second connector structure to define the low gear state of the electric drive unit.

8. The electric drive unit of claim 7, further comprising:
a first bearing that extends between the rotor shaft and the first connector structure; and
a second bearing that extends between the first carrier structure and the second connector structure.

9. The electric drive unit of claim 7, wherein during rotation of the rotor shaft by the motor in the first rotational direction in the high gear state, the first connector structure, the second sun gear, the plurality of second planet gears, the second carrier structure, the second ring gear, and the second connector structure are substantially rotationally stationary relative to the axis.

10. The electric drive unit of claim 7, wherein during rotation of the rotor shaft by the motor in the first rotational direction in the low gear state, the second carrier structure is substantially rotationally stationary relative to the axis, the second connector structure rotates with the first carrier structure about the axis, the second ring gear rotates with the second connector structure about the axis, the second planet gears rotate about respective second planet gear axes, the second sun gear rotates about the axis, and the first connector structure rotates with the second sun gear about the axis.

11. An electric drive unit, comprising:
a housing;
a motor that drives rotation of a rotor shaft about an axis;
a first planetary gearset, comprising:
a first sun gear coupled to the rotor shaft;
a plurality of first planet gears that interface with the first sun gear;
a first ring gear that interfaces with the plurality of first planet gears; and
a first carrier structure operably coupled with the plurality of first planet gears, such that revolution of the first planet gears rotates the first carrier structure;
a second planetary gearset, comprising:
a second sun gear;
a plurality of second planet gears that interface with the second sun gear;
a second ring gear that interfaces with the plurality of second planet gears; and
a second carrier structure to which the plurality of second planet gears are operably coupled, the second carrier structure being rotationally fixed relative to the axis;
a first connector structure that extends between the first ring gear and the second sun gear to rotationally fix the first ring gear relative to the second sun gear with respect to the axis;
a second connector structure that is fixed to and extends from the second ring gear; and
a shifter operably coupled with the second connector structure and operable between a first condition, wherein the shifter couples the second connector structure to the housing to define a high gear state of the electric drive unit, and a second condition, wherein the shifter couples the first carrier structure with the second connector structure to define a low gear state of the electric drive unit;
wherein during rotation of the rotor shaft by the motor in a first rotational direction in the high gear state, the first sun gear rotates about the axis, the first planet gears rotate about respective first planet gear axes and revolve about the axis, the first carrier structure rotates about the axis, and the first ring gear, the first connector structure, the second sun gear, the plurality of second planet gears, the second carrier structure, the second ring gear, and the second connector structure are substantially rotationally stationary relative to the axis; and
wherein during rotation of the rotor shaft by the motor in the first rotational direction in the low gear state, the second carrier structure is substantially rotationally stationary relative to the axis, the first sun gear rotates about the axis, the first planet gears rotate about the respective first planet gear axes and revolve about the axis, the first carrier structure rotates about the axis, the second connector structure rotates with the first carrier structure about the axis, the second ring gear rotates with the second connector structure about the axis, the second planet gears rotate about respective second planet gear axes, the second sun gear rotates about the axis, the first connector structure rotates with the second sun gear about the axis, and the first ring gear rotates with the first connector structure about the axis in a second rotational direction that is opposite the first rotational direction.

12. The electric drive unit of claim 11, wherein the first carrier structure is operable to output a first amount of torque in the high gear state and a second amount of torque in the low gear state, wherein the first amount is less than the second amount.

13. The electric drive unit of claim 11, further comprising:
a differential that is operably coupled with the first carrier structure.

14. The electric drive unit of claim 13, wherein the first carrier structure includes a pinion that is configured to interface with a wheel gear operably coupled with the differential.

15. The electric drive unit of claim 11, further comprising:
a first bearing that extends between the rotor shaft and the first connector structure; and
a second bearing that extends between the first carrier structure and the second connector structure.

16. A gear system, comprising:
a first planetary gearset, comprising:
a first sun gear configured to rotate about an axis;
a plurality of first planet gears that interface with the first sun gear;
a first ring gear that interfaces with the plurality of first planet gears; and
a first carrier structure operably coupled with the plurality of first planet gears, such that the revolution of the first planet gears rotates the first carrier structure, wherein the first carrier structure is operably coupled with the first ring gear, such that rotation of the first sun gear about the axis in a first rotational direction prompts rotation of the first carrier structure about the axis in the first rotational direction and rotation of the first ring gear about the axis in a second rotational direction opposite the first rotational direction.

17. The gear system of claim 16, further comprising:
a second gearset that operably couples the first carrier structure with the first ring gear.

18. The gear system of claim 17, wherein the second gearset is a second planetary gearset, comprising:
a second sun gear;
a plurality of second planet gears that interface with the second sun gear;
a second ring gear that interfaces with the plurality of second planet gears; and
a second carrier structure to which the plurality of second planet gears are operably coupled, the second carrier structure being rotationally fixed relative to the axis.

19. The gear system of claim 18, wherein the first carrier structure and the second ring gear are configured to rotate together at a common rate of rotation about the axis.

20. The gear system of claim 19, wherein the first ring gear and the second sun gear are configured to rotate together at a common rate of rotation about the axis.
